(19) United States
(12) Patent Application Publication
(10) Pub. No.: US 2026/0227887 A1
(43) Pub. Date: Aug. 6, 2026

(54) PROFILE DRIVEN AI/AGENT WITH DYNAMIC REFINEMENT (PDADR)

(71) Applicant: Salesforce, Inc., San Francisco, CA (US)

(72) Inventors: Daniel Thomas Harrison, Newmarket (CA); Natalija Pavic, Toronto (CA)

(73) Assignee: Salesforce, Inc., San Francisco, CA (US)

(21) Appl. No.: 19/043,195

(22) Filed: Jan. 31, 2025

(51) Int. Cl. G06F 3/0484; G06F 3/0482; G06F 3/0483; G06F 9/445; G06F 9/451

(52) U.S. Cl. CPC G06F 3/0484; G06F 3/0482; G06F 3/0483; G06F 9/44526; G06F 9/452

(57) ABSTRACT

One method of receiving a web page request by a user, identifying a plurality of components to be included on the web page responsive to the web page request based on an initial assessment of the user's preferences, transmitting the web page comprising the plurality of components to the user, inserting a plug-in mechanism in response to the web page to incorporate a plurality of selectable graphical user interface (GUI) elements associated with respective components of the plurality of components of the web page, dynamically determining an updated assessment of the user's preference based at least in part on the user selection and the initial assessment of the user's preferences, and iteratively updating the respective components of the plurality of components of the web page associated with the respective ones of the plurality of selectable GUI elements.

### TECHNICAL FIELD

One or more implementations relate to database systems capable of providing targeted content to users in response to identifying specific preferences of the users that request content pages according to their specific preferences, learning requirements or engagement style.

### BACKGROUND

Many current content delivery systems cannot design information that is designed for a target audience. In other words, current content delivery systems may give boilerplate information that may appeal to some users, but also may be ignored or not consumed at all by other users. Excessive marketing hype, poorly written content or other information that is not delivered in a digestible manner can impair the user experience. For example, many users may want extremely concise and factual information when looking to solve a problem or buy a product. Other users, on the other hand, may want to be provided with detailed stories that they feel make an emotional connection. Other users may be looking for humor or extreme messaging that invokes reaction and lasting memories and retention. The way users target and consume information and what the users are seeking can vary from user to user.

As such, much content that is currently being provided is not being read, consumed, or retained by many users. A lot of efficiency is being reduced in terms of providing information that is specific and needed by certain users.

A goal for information providers to be to identity the type of information that their target audience is seeking. Yet another goal or objective for information providers is to identify what platform in which the target audience would like to receive the information. Further, information providers should also understand what feedback that the target audience can provide to help the information providers more succinctly provide the information to the target audience, or awareness.

A need exits to provide information that is more targeted to each particular user. Further, a need exists for information providers to narrow previously delivered information that is more pertinent to what the users are seeking. Another need therefore exits for users to provide feedback to adjust previously provided information to be more targeted to the information that the users are seeking.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 depicts flow diagram of a system that provides an interactive process for a user to obtain targeted content from the system according to some exemplary implementations;

FIG. 2 is a flow diagram illustrating a system that provides target content in accordance to user preferences according to some example implementations;

FIG. 3A illustrates an application of a plug-in mechanism on a computing system to filter content on a content page in relation to user preferences according to some example implementations;

FIG. 3B depicts another illustration of the plug-in mechanism on the computing system, in which content can be added, highlighted, or removed from the content page according to some example implementations;

FIG. 4 illustrates a flowchart of a method according to some example implementations;

FIG. 5A is a block diagram illustrating an electronic device according to some example implementations; and

FIG. 5B is a block diagram of a deployment environment according to some example implementations.

### DETAILED DESCRIPTION

The following description describes implementations for providing target content to users online. Users can use online systems to try to obtain content that is specific to the information they are targeting and wish to engage in and consume. The following implementations improve the efficiency in which computing systems provide information to users. The computing system, through user feedback using a plug-in mechanism, is more readily able to identify the content style/preference that the user is seeking. The computing system becomes more efficient at providing the information that the user is seeking, and can reduce the time it takes to provide the content as well. The computational efficiency of the computing system is improved as a result. Moreover, with each iteration with the user, the computing system can provide the targeted content to the user more efficiently. The computing system can thereby more efficiently reduce the amount of unwanted content to the user with each iteration.

The features of the invention, with the plug-in mechanism, can increase the user interaction with the computing system. The plug-in mechanism or hypertext markup language (HTML) code can provide a software platform for the user to interact with the computing system in real-time over multiple time intervals. The plug-in mechanism can allow the user to interactively communicate with the computing system to update content provided to the user by the computing system. Through voice commands and keyboard commands, the user is able to interact in real-time with the computing system and have the content adjusted efficiently that is not typically done by other computing systems. Further, the user can receive self-help information relating to therapy and medication with interactive plug-in sessions that are not typically provided by other computing systems.

When the user sends a request for information through the computing system (system), the system using artificial intelligence (AI) and a profile driven agent AI/agent force with dynamic refinement (PDADR) processor, can identify information from the user based on the request and what is publicly known about the user. The AI and PDADR processor can function in a substantially similar manner as other AI and processors that are utilized by other computing systems. If not much information is known on the user, the PDADR processor and AI can create a profile for the user by obtaining information on the user from social media sites such as, but not limited to, Facebook and Instagram.

Once the profile is created on the user, the system can begin to create a content page that is targeted to the user's preferences based on the computing system's initial assessment of the preferences of the user. The initial assessment can occur based on the user sending web search request, public information known on the user from public sites and public information, and information that the computing system obtained from the user from social media sites. Once the content page is created, the content page can be transmitted back to the user for the user to view on the user interface of the system. The computing system puts together the content page based on the information gathered on the user from the web content request, from public sites, public information, and from any additional information which the computing system had to obtain from social media sites.

The plug-in mechanism/adapter can be available for the user to use to interact with the computing system in multiple intervals. Part of the interaction can include the user highlighting information more aligned with the user's preferences and deleting information that may not be aligned with the user's preferences. The interaction can also include the user using keyboard commands and voice commands including emoji's (thumbs up for approval, etc.) through the plug-in mechanism to communicate with the system what further changes to the content page should be made. The user can thereby, by using the plug-in mechanism, alert the system if the information is suited for them, or if the information has to be modified, and if other additional information is needed. In other words, the plug-in mechanism can provide an interactive forum for the user to alert the system what information should be minimized or deleted, and what information should be added and expanded.

The user can use the plug-in mechanism over multiple sessions to alert the system when new information or different information is required. The information which the user is seeking can be in relation to medicine, therapy, service, or product information which the user requires. The user can apply the plug-in mechanism interactively with the system until the system, through the necessary iterations, provides the user with the specific content which the user was seeking. The plug-in mechanism can provide an interactive software platform for the user to communicate with the computing system on any changes that should be made to the content page to clarify the user's preferences from the initial assessment which the computing system had previously made on the user's preferences. As a result, the plug-in mechanism can enable the user to ultimately obtain the targeted content which the user would find engaging and which the user be according to the user's preferences.

The following embodiments illustrate in detail how the user can obtain more targeted information from an initial request. The following embodiments illustrate how the user can apply the plug-in mechanisms to assist the PDADR processor and AI with providing more targeted content that is more specific to the user's preferences. As, the following embodiments show exemplary embodiments how the user can ultimately receive the desired content from an initial request for content from the computing system.

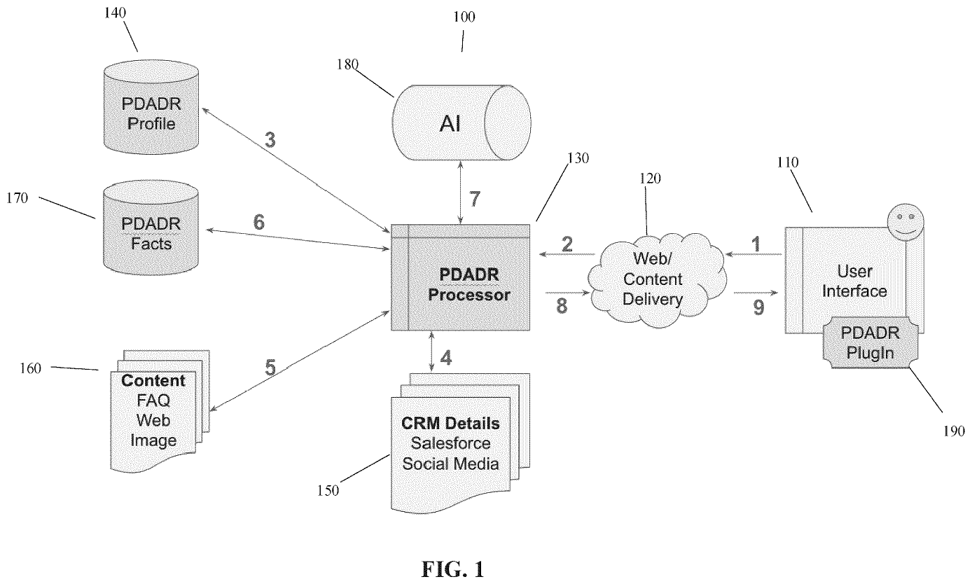

FIG. 1 depicts a flow diagram 100 in which a user can send a request to a computing system to receive a content page that is pertinent to the specific preferences and interests of the user. The request can be in relation to any type of content which the user is seeking. The content can be in relation to a specific lawnmower. In other embodiments, the request can be in relation to a type of medicine or therapy that the user is seeking. Further, in other embodiments, the request can be in relation to financial advice which the user may be seeking as well. As such, the request can involve a wide variety of topics that is very user specific and based on preferences of each user.

Referring again to FIG. 1, at the user interface 110 of the computing system, the user can send the request for the content page as illustrated by the web content delivery 120. The request can be received by the PDADR processor 130. Upon receiving the request, the AI 180 can work in conjunction with the PDADR processor 130 to identify information on the user. The information can include what is revealed about the user through the web content delivery 120 representing the request from the user for the content page. The PDADR profile 140 of the user can be illustrated in part from the web content delivery 120. The interests and preferences of the user can be inherently or directly revealed from the web content delivery 120. The PDADR profile 140 can also be searched on public sites on the internet and other public sources of information that are available on the user. The public sites on the internet and the public sources of information also can reveal what is known about the user as well. If no information can be found on the user, the AI 180 can search social media sites to identify the specific interests and information on the user.

In FIG. 1, the AI 180 and PDADR processor 130 can look to social media sites such as, but not limited to, Facebook and Instagram. As many user interests tend to be directly revealed on one or more social media sites, the social media sites can further reveal particular interests and likes of the user. The social media sites, as illustrated by the CRM details 150, can assist the AI 180 and PDADR processor 130 with further putting together the content page because specific preferences and interests with respect to content of the user can be further identified. In addition, it may be difficult to find information on the user that is public. As such, facts from the social media sites can assist the AI 180 and PDADR processor 130 in identifying the type of content that the user prefers that are not publicly available.

In FIG. 1, the content page can thereby be put together using information on the user from a variety of sources. The variety of sources can include facts on the user from the web content delivery 120, CRM details 150 from social media sites, PDADR facts 170 on the user that is public, and also a public PDADR profile 140 on the user can all be used put together a content page 160. The PDADR processor 130 can validate the PDADR facts 170 using comparison/validation algorithms and also confirmation algorithms. Once the content page 160 is packaged according to the user's preferences, the content page 160 is put together by the AI 180 and PDADR processor 130 and delivered by the web content delivery 120 to the user interface 110 for the user to view. The user can then use multiple intervals to adjust the content page 160 according to the user's preferences.

In FIG. 1, when the content page 160 is viewed by the user on the user interface 110, a PDADR plug-in 190 can be applied by the user. The user can apply the PDARD plug-in 190 to further specify the user preferences over multiple intervals. The PDADR plug-in 190 can be used to delete content that is not what the user wants to see. The user can determine that much of the content that is on the content page 160 is not what the user is targeting. The user may want a more technically targeted preference that includes specific repair information on a lawnmower as opposed to general information on the safe use of the lawnmower around flower gardens or pets. In such an instance, the user can use the PDADR plug-in 190 to have the extraneous content removed. The user can use keyboard commands and voice commands to communicate these preferences.

In FIG. 1, the PDADR plug-in 190 can also be used to request additional content and add and highlight content which the user would want to see on the content page 160. The PDADR plug-in 190 can be applied to distinguish pertinent information from non-significant information on the content page 160. Moreover, the PDADR plug-in 190 can be applied to add additional content not provided by the content page 160. The user can add the additional content in multiple intervals and sessions using the PDADR plug-in 190. With respect to the lawnmower recited above, the plug-in mechanism can enable the content page 160 to be adjusted with respect to the user's preferences in relation to self-driving lawnmowers and other types of lawnmowers. Further, using the PDADR plug-in 190, the user can have several interactive sessions with the AI 180 and PDADR processor 130 to get the additional targeted content that more closely pertains to the user's preferences.

In FIG. 1, the PDADR plug-in 190 can provide an interactive forum for the user and computing system to enable the user to alert the system of specific details on the preferences of the user. The PDADR plug-in 190 can be applied to provide an interactive session to clarify the preferences of the user. Further, several interactive sessions can be provided in response to the PDADR plug-in 190 to update the content from the content page 160. The interactive sessions can include, but are not limited to therapy sessions, self-help sessions, sales, product detail, training, educational, or tutorial sessions in relation to the targeted content which the user is seeking. The PDADR plug-in 190 can be applied to provide therapy sessions, tutorial sessions, or product detail sessions to the user in several interactive intervals. The PDADR plug-in 190 can allow the user to perform direct highlighting and provide feedback using text, emoji's, and icons. The user can use keyboard commands on the user interface 110.

Referring to FIG. 1, the user can also use voice commands and hand gestures (eg. VR, webcam, phone) and phone commands through the PDADR plug-in 190 to minimize or expand the view of the content. Through the use of the various commands with the PDADR plug-in 190, the user can alert the system to provide additional content that pertains to the content the user is seeking. The PDADR plug-in 190 can also enable the user to remove content that may be unrelated to the user's preferences. There is also an ability to take channel specific feedback from the user from the user interactions of the PDADR plug-in 190. There can also be a channel agnostic adapter to listen to interactions with the user on different endpoints such as, but not limited to, the browser, a mobile device, or by voice commands.

In FIG. 1, as a result of the application of the PDADR plug-in 190, the AI 180 and PDADR processor 130 can then update the content page 160 that is more specific to the targeted content of the user for the user to view on the user interface 110. Through the necessary iterations from the PDADR plug-in 190, the user is able to obtain more targeted content that is aligned with the user's preferences. In other embodiments, other users can go through the process 100, and have the content page 160 updated according to their targeted preferences. As such, the content page 160 can be updated for additional users based on targeted content and preferences of the additional users as well.

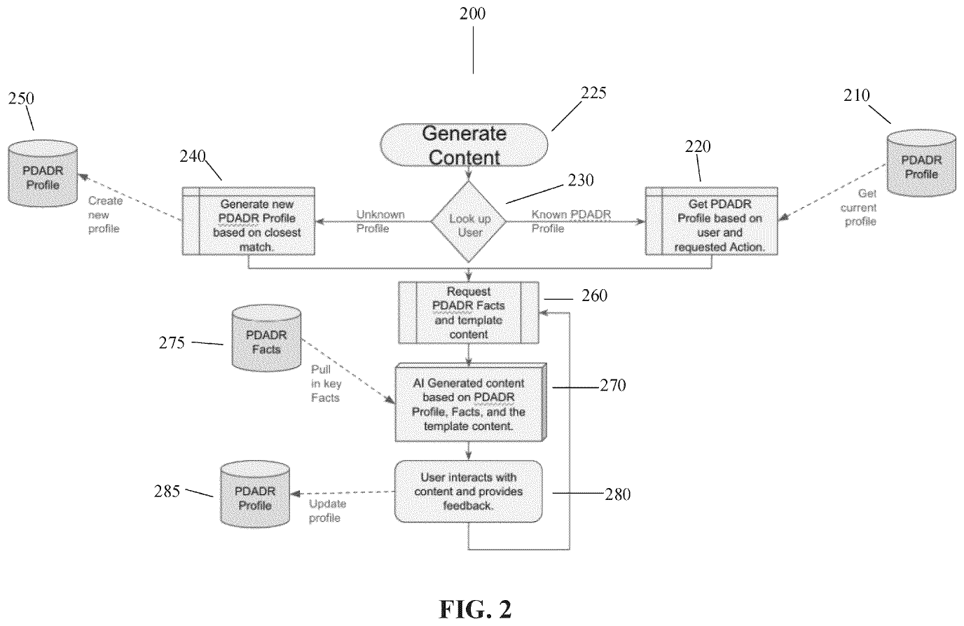

Referring to FIG. 2, a flow diagram 200 is illustrated that further describes the process 100 of FIG. 1. A computing system using AI and the PDADR processor as described in FIG. 1, can attempt to generate content for a content page that aligns with preferences of a user. A PDADR profile 210 can be part of a requested action 220 for content to the computing system that aligns with the user's preferences. The requested action 220 can be the user sending a search query, web page request, or request for a particular type of content to the computing system. The requested action 220 can be based on content that is specific and dependent on the user's specific preferences and interests. The computing system can generate content 225 and also look up facts 230 on the user based on the requested action 220 sent by the user requesting the targeted content. The requested action 220 can reveal the interests and preferences of the user. In some embodiments, there is not much information that can be gathered on the user based on the requested action 220. There also may not be much information on the interests of the user or who the user is that is publicly known or shared online. In such instances, the computing system can generate a PDADR profile 250 of the user based on the closest match 240.

In FIG. 2, the AI and PDADR processor of the computing system can look at social media sites, such as, but not limited to, Facebook and Instagram to further identify interests and preferences of the user with respect to desired content. Moreover, a default profile can be generated for the user to supplement missing information from at least one social media site. In such instances, the requested action 220, information from sites, and other public information may not provide the information required for a profile. As such, the social media sites can reveal information about the user that was not shown in the requested action 220 or available on other public sites. In either instance, the computing system can obtain the PDADR profile 210 of the user from the requested action and other known public information. Alternatively, the computing system can obtain the PDADR profile 250 of the user based on the closest match 240 of information found on social media sites. The AI and PDADR processor can put together the content page based on the PDADR profile 250 based on the closest match 240 or the PDADR profile 210 in relation to the requested action 220.

With continued reference to FIG. 2, the computing system can initiate PDADR facts requests 260 for the content page. The PDADR facts requests 260 can be when the computing system requests facts on the user from the requested action 220, from information known on the user from public sites, and from public information known on the user. The PDADR facts requests 260 can also be when the computing system requests facts on the user from social media sites because not enough facts can be obtained from the requested action 220, or from public sites, or from public information. As such, the facts can come from either the PDADR profile 210 based on the requested action 220 or the PDADR profile 250 based on the closest match 240 wherein, the closest match 240 can be obtained from social media sites. PDADR facts 275 can then be pulled in by the computing system to provide the AI generated content page 270 based on the facts of the PDADR profiles 210/250 and the PDADR facts 275 facts that are requested. The PDADR facts 275 additionally provide the repository of key content information that is required such that even when the users preferences may be directing the generated content page 270 to be presented in a specific way, the PDADR fact 275 cannot be omitted. This may be safety information for the product, drug or conditional availability of the information such as an expiry date for a product or warranty. The content page 270 can then be delivered to the user to view on the user interface. In response to the user receiving the content page, the user can apply the plug-in mechanism to more closely filter the content to the user's preferences. The user can provide feedback 280 on the content page 270.

In FIG. 2, with respect to the feedback 280, the user can highlight which content should be removed, and use voice commands and keyboard commands to indicate which content should be added. The user can apply the plug-in application/mechanism in multiple intervals to assist the AI and PDADR to update the content page 270 to more closely to the users'preferences. Additional facts from the PDADR profile 285 can be obtained to further clarify the user's preferences. The user may assert using the plug-in application/mechanism that the user wants more of the content that was provided in the content page 270. Alternatively, the user feedback 280 can include removing extraneous content unrelated to the user's preferences. Through any number of interactive sessions using the plug-in mechanism, the feedback 280 can alert the system to update the content page 270 to remove the extraneous content.

Referring again to FIG. 2, in other embodiments, the feedback 280 can be provided by the user to add different additional content. The user can request different additional content than what is seen in the content page 270. The user may wish to acquire specific information on a product such as a car or lawnmower, and less specific information on homes or pets that the AI and PDADR processor originally put together on the content page 270. Still in other embodiments, the user can also indicate that much of the content that was provided on the content page 270 was pertinent to the targeted content, but that more of such content was needed. The user can use keyboard and voice commands to indicate why more of the additional content is needed. As with removing the content, the adding of the content to the content page 270 can occur over the desired number of intervals required by the user. In any such in exemplary implementation, the user is able to provide the system with the feedback 280 to update the content page 270 to align with the user's preferences for targeted content to allow the user to consume and retain the information.

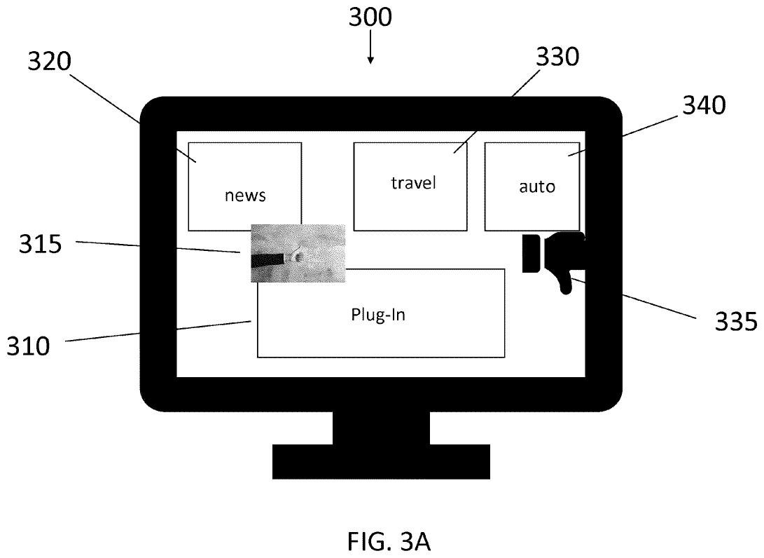

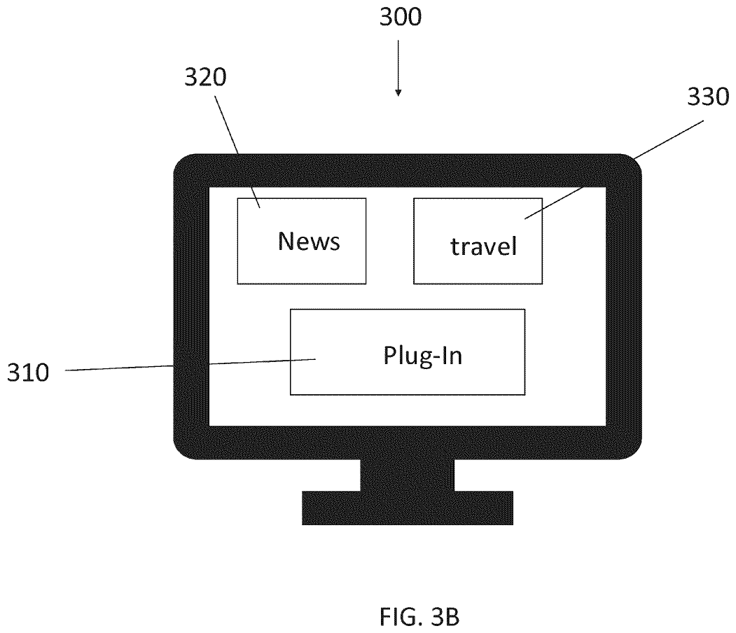

In one implementation, in FIG. 3A, the GUI display components 320, 330, 340 of a web page GUI display 300 are dynamically generated at run-time using corresponding web components added to the layout of the web page GUI display 300. For example, a developer user may utilize a page builder feature of an application platform to add instances of web component templates to a web page and define values for the fields associated with the respective web component templates. In this regard, the configurable web component templates generally represent self-contained and reusable elements or other resources that may be added or otherwise incorporated into the web page GUI display 300 and generated or otherwise rendered at run-time in accordance with user-defined or user-configured values for various metadata fields or parameters of the respective web component template. For example, the configurable web component templates may correspond to configurable web components for various GUI elements, such as buttons, text boxes, lists, menus, and/or the like, which may be added to the web page GUI display 300 in a drag and drop manner and then manually configured by a developer user. The page builder feature of the application platform may be configurable to generate and store configured instances of the web component templates in the component database as configured web components associated with a user or tenant's instance of a virtual application that maintains the user-defined values for the respective instances of the web component templates in association with the other code and/or data defining the layout, rendering, or behavior of the respective web component templates added to the respective web page GUI display 300.

In FIG. 3A, exemplary implementations of the configured web components include presentation code (e.g., Hypertext Markup Language (HTML), cascading style sheet (CSS), and/or the like) defining the manner in which the configured web component is to be displayed, rendered or otherwise presented by the client application. The configured web component may also include behavioral code (e.g., JavaScript or other client-side executable code) defining the event-driven behavior of the configured web component within the client application (e.g., in response to user actions, server actions, an event associated with another web component, etc.). The configured web component also includes the user-defined metadata for the configured web component which may be invoked, referenced, or otherwise utilized by the presentation code and/or behavioral code to generate and render the configured web component. Accordingly, the configured web components may be dynamic, with the content and/or behavior thereof varying each time a web page GUI display including one or more configured web component(s) is viewed or accessed.

Referring again to FIG. 3A, in some implementations, the web page GUI display 300 may be implemented or otherwise realized as an aggregate web component that includes HTML code or other presentation code that defines the layout, graphical structure, spatial arrangement or other visual characteristics of the constituent GUI display components contained therein along with JavaScript code or other client-side executable behavioral code that defines the event-driven behavior associated with the web page GUI display 300 and constituent component metadata identifying the respective configured constituent GUI display components to be invoked and rendered within the web page GUI display 300 in accordance with the user-defined positioning and spatial arrangement of the constituent GUI display components. In such implementations, when rendering a web page GUI display based on a URL or web page file of a virtual application, the client application retrieves and executes the presentation code to generate the GUI display components within the web page GUI display 300 associated with the virtual application by utilizing the constituent component metadata to retrieve and dynamically render the configured constituent web components to populate the respective regions of the web page GUI display 300.

In regard to FIG. 3A, the web page GUI display 300 is illustrated in which the plug-in (via browser add-on, HTML code, or other platform capabilities) 310 is illustrated. The plug-in 310 can provide the user with an interactive forum to communicate any edits to content that the computing system can provide. Moreover, the plug-in 310 can provide an interactive forum for the user to alert a system of specific details on the user's preferences. Upon sending the request for content, the computing system can identify the user preferences from the request and from other public information that is known on the user. In the event that information on the user is unknown, the system with the AI can identify information on the user from social media sites such as Facebook and Instagram. The AI of the computing system can use the information on the user to put together a content page that packages content together based on the preferences of the user. The computing system can transmit the content page to the user to view on the user interface. The content page can be what the PDADR processor and AI of the computing system initially determined to be the perceived preferences of the user in relation to the content. The user can therefore insert the plug-in 310 to interact with the computing system and alert the computing system on how aligned the content actually is with the users'preferences.

Referring again to FIG. 3A, the content can include GUI elements 320, 330, and 340 that include news, travel, and auto respectively. The computing system can provide the content in relation to the news, travel, and auto based on an initial assessment of the user's preferences and interests. In response, the user can then apply the plug-in 310 to alert the computing system on whether the any content should be added or removed based on the preferences of the user. As such, GUI elements 320, 330, 340 are provided on a multimodal interface to allow the user selection through text commands, voice inputs, and gesture-based controls. The user can use voice commands and keyboard commands to add, highlight, expand, minimize, and remove information. The user can use emoji's to alert the computing system regarding the specific preferences of the user. The emoji's can include a thumbs up emoji 315 to indicate approval of the content with respect to news, GUI element 320 and travel, GUI element 330. The emoji's can also include a thumb down emoji 335 to indicate the user's disapproval of the content with respect to auto, GUI element 340. As such, the computing system can be alerted as to which content should remain and be expanded upon, and which content should be removed. As such, the plug-in 310 can be applied to provide an interactive session to provide the user selection to clarify the user's preferences with respect to the GUI elements 320, 330, 340. The content within the GUI elements 320, 330, 340 on the web page within the web page GUI display 300 can be rearranged based on the user selection. Moreover, decentralized processing can be provided across multiple computing nodes to enable the content within the GUI elements 320, 330, 340 to be refined through a distributed artificial intelligence (AI) architecture within the database system.

In FIG. 3A, multiple portions of the GUI elements 320, 330, 340 on the web page GUI display 300 can be rearranged based on an approval provided by the user selection. The refinement of the content through the user selection shown by the emoji's 315, 335 can provide a modification of images, videos, or interactive components on the web page shown on the web page GUI display 300. Moreover, the plug-in 310 can provide refinement of the content within the GUI elements 320, 330, 340 across multiple platforms that include web browsers, mobile applications and voice assistants. The refinement of the content within the GUI elements 320, 330, 340 can be based on industry specific requirements. The computing system can detect user interaction patterns based on the user selection of the emoji's 315, 335 to refine the content in real time. The plug-in 310 can be used over multiple intervals to update the content page more specifically to the user's preferences.

Referring to FIG. 3B, the computing system is illustrated with the plug-in 310 and updated web page GUI display 300. The user can apply the plug-in 310 and apply the thumbs up emoji 315 and thumbs down emoji 335 during a session to indicate approval and disapproval of the initial content. As such, the content page of the computing system can be updated. As a result, the content and GUI elements 320, 330 in relation to news and travel can remain. The plug-in 310 can enable the GUI elements 320, 330 with respect to news and travel to be adjusted according to the user selection. Further, the computing system can also provide more content in relation to the news and travel that the user approved of. In contrast, the content in relation to auto and GUI element 340 can be removed. As such, the user has the option with the plug-in 310 to add or remove portions of the content by indicating the approval and disapproval of the initial content provided 320.

In FIG. 3B and in embodiments, the sessions can include narrowing the information on a commercial product that is specific to the user's preferences. For instance, the user can be a product owner. The PDADR system may initially identify the user's interests to be more related to gardening and pets based on the initial request for content and information on the user on social media sites. As such, the computing system may initially send the user a content page with a heavy focus on gardening and pets with photos and stories. In response, the user can apply the plug-in 310 to update the content. The user may want the computing system to know that the user is not seeking to consume content in relation to gardening and pets that the computing system initially believed were related to the user's preferences. The user may therefore alert the computing system to update the content to provide more product maintenance with technical details instead of photos and stories. Moreover, the user can update the content to indicate much of the content on gardening and pets is not necessary, and more content on the tools needed to handle a lawnmower of interest to the user is needed. Based on this feedback, the AI of the computing system can refactor the content page so that the user sees an updated content page that is more targeted to the user's preferences. The computing system can refactor the content in multiple intervals as well.

Referring again to FIG. 3B, the plug-in 310 enables the web page GUI display 300 to dynamically refactor the content such that the user will feel in more control over how the user is consuming the information. The user can feel more in control of the content and the computing system and can learn to more efficiently refactor the content for each particular user. The feedback from the user can allow the computing system to identify the content that is important to the user and which also engages the user. The computing system can also identify from the feedback which content is uninteresting such as the gardening and pets example described above which will provide a more engaging experience and drive more knowledge retention of the relevant and important information. The user can also engage with the computing system in multiple intervals in relation to the content. As mentioned above, a variety of engagement styles using voice and keyboard commands can be used with the plug-in 310.

In FIG. 3B, with the keyboard commands, the user can highlight the desired content, and also give an approval or disapproval (thumbs-up emoji 315 or thumbs-down emoji 335, etc.) of the content. With the voice commands, the user can tell the computing system the additional content that the user prefers. The web page GUI display 300 can also provide a prompt to ask the user if the user likes the content, or if the user prefers additional content. The user can also use hand gestures to notify the web page GUI display 300 of additional content or to remove some of the initial content. The preferred means of communication can be used by the user interactively to enable the content to be dynamically updated in real-time.

Referring again to FIG. 3B, passive feedback is also possible. In particular, on a mobile device, it is easy to track which section of the page is on the screen as a user scrolls down. Like with the above computing system, and the trailhead page in the computing system, the information providing background and context is often at the top of the page which gets more detailed as the page goes on. The detailed part of the information, with the summary at the end of the page that recaps the content can appear. One user type such as a general user might like reading the background information and look at all the photos within the content, then also spend time on the middle and end of the content, such that the page was perfectly structured for this user. In contrast, a more detailed user might scroll past that content quickly and spend most of the time on the middle section. Then, when that user arrives at the summary at the end, this user might skip right over the summary as being redundant. It can be easy for the PDADR to provide pages that only provide the detailed and complete middle section for this user. Another type of user can be in a hurry and would not need to see the background or detail of the content, but just wants to see a quick summary of the content. The passive feedback can therefore work for a variety of users.

The benefits of the interactive feedback from the user can enable the computing system to more consistently provide content pages that are aligned with current needs and engagement preferences of the user. The user will not have to spend excessive time looking at information that is not of interest to the user. The feedback with the plug-in 310 can also enable the computing system to eventually reduce the number of interactions and inputs required from the user to get the targeted content that the user is seeking while still maintaining the brand recognition of the computing system. Other benefits therefore can include improved accuracy in generating content pages. The computing system can improve dynamically and use less iterations over time to produce the content for each specific user. The computing system can thereby learn to initially produce the content that is closer to the user preferences so the plug-in 310 is used in fewer intervals by the user.

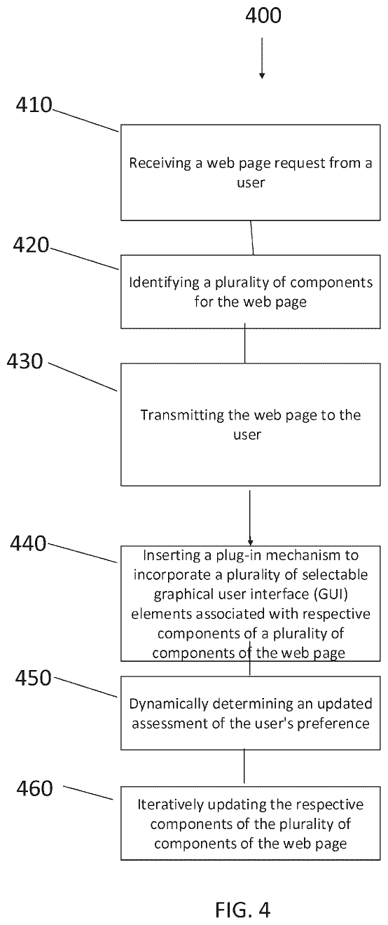

Referring to FIG. 4, a flowchart 400 is illustrated in which a web page with content based on identifying information and an initial assessment of the user's preferences is provided. The web page can be associated with an instance of a web application generated by an application platform of a database system. The content on the web page can be dynamically updated based on the approval and disapproval that the user can provide to the content on the web page. The user can use the plug-in mechanism to communicate with the computing system to approve or disapprove of the content provided. As a result, the content on the web page can be updated, rearranged, and removed based on the user the preferences in relation to the content provided.

At step 410, a web page request can be received by the user. The user can send the web page request to receive the content aligned with the user's preferences.

Next at step 420, identifying a plurality of components to be included on the web page responsive to the web page request based on an initial assessment of the user's preferences. Furthermore, the computing system can determine whether additional information on the user is required after performing the initial assessment of the user's preferences. The computing system can then determine the type of content that should be provided on the web page based on an initial assessment of the content that the user prefers.

Further, at step 430, the computing system can then transmit the web page comprising the plurality of components to the user. The web page can be based on the identifying information of the user and the initial assessment of the user's preferences.

At step 440, a plug-in mechanism can be inserted in response to the web page received. The plug-in mechanism can be inserted in response to the web page to incorporate a plurality of selectable graphical user interface (GUI) elements associated with respective components of a plurality of components of the web page, wherein a respective selectable GUI is configurable to modify the content of a respective component on the web page. Further, there can be a user selection of the respective components of the plurality of GUI elements. Several interactive sessions can be provided in response to the plug-in mechanism to update the GUI elements based on the user selection. The plug-in mechanism can be applied to indicate which content among the GUI elements that the user approves based on the user selection.

Then, at step 450, in response to the user selection, the computing system can dynamically determine an updated assessment of the user's preference based at least in part on the user selection and the initial assessment of the user's preferences. The computing system can perform an updated assessment of the user's preference as a result of the user selection. The computing system can thereby adjust a complexity level and detail level of at least one of the GUI elements based on the determination of the updated assessment of the user's preferences. Further, wherein the plug-in mechanism can be applied to add additional content based on the updated assessment of the user's preferences. In addition, the plug-in mechanism can be applied to selectively cache the content aligned with the updated assessment of the user's preferences and filter the content not aligned with the updated assessment of the user's preferences.

At step 460, and also in response to the user selection, the computing system can iteratively update the respective components of the plurality of components of the web page associated with the respective elements of the plurality of selectable GUI elements.

Benefits of the embodiments described above can include improved accuracy of agents and personal assistants for better engagement. The computational system can have a faster and more efficient cycle to move the customer/client to the end goal for providing the targeted content that the user wants for both the user and the business. The various ways in which the user can be interactive by voice, keyboard, and emoji's can expediate the process of the system understanding the type of information being sought and how the information should be presented.

Better content and information can be obtained faster as the key points of content that are important and aligned to the user's way of consuming information are identified. The right story and corporate branding goals can be aligned based on the persona-based profiles in PDADR. The content from companies that produce irrelevant content can be reduced and eliminated. As such, the time the user spends reading or viewing irrelevant content can also be substantially reduced.

Overall, the computing system can become more efficient at specifically identifying the information that each user is likely to consume, and which information which each user is likely to find irrelevant. Through interactive sessions with the user and with each iteration, the computing system can reduce the time it takes to produce targeted content with each user.

With each iteration, the computing system and PDADR with AI becomes more efficient at identifying and providing the targeted content which that user is likely to engage in and find relevant. As such, with each iteration, less time is spent by the computing system in producing content that is not sought the user. The computing system can therefore become computationally efficient at producing targeted content that can be specific to each user.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

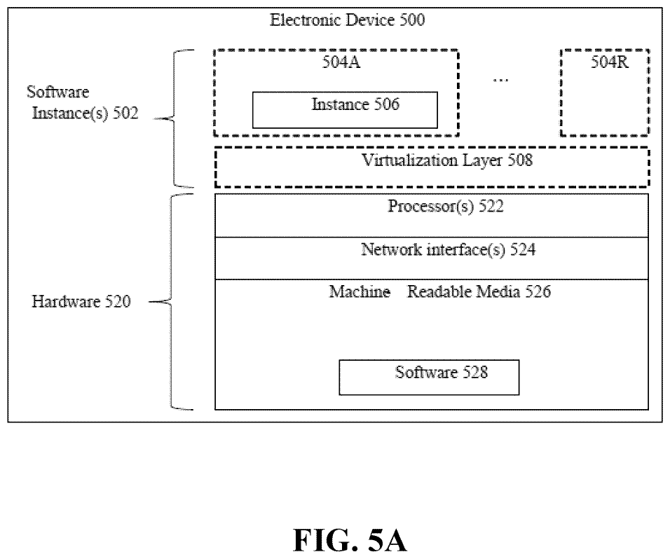

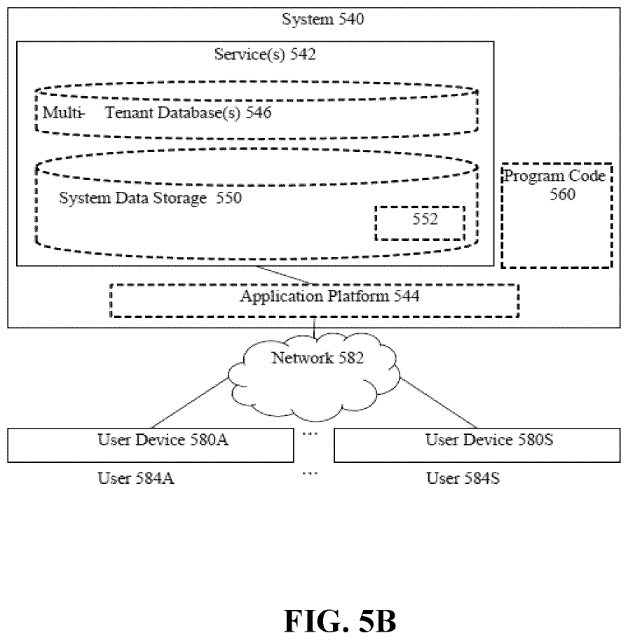

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and machine-readable media 526 having stored therein software 528 (which includes instructions executable by the set of one or more processor(s) 522). The machine-readable media 526 may include non-transitory and/or transitory machine-readable media. Each of the previously described clients, web application firewall services and client-side services may be implemented in one or more electronic devices 500. In one implementation: 1) each of the clients is implemented in a separate one of the electronic devices 500 (e.g., in end user devices where the software 528 represents the software to implement clients to interface directly and/or indirectly with the web application firewall services and/or client-side services (e.g., software 528 represents a web browser, a native client, a portal, a command-line interface, and/or an application programming interface (API) based upon protocols such as Simple Object Access Protocol (SOAP), Representational State Transfer (REST), etc.)); 2) the web application firewall services and/or client-side services is implemented in a separate set of one or more of the electronic devices 500 (e.g., a set of one or more server devices where the software 528 represents the software to implement the web application firewall services and/or client-side services); and 3) in operation, the electronic devices implementing the clients and the web application firewall services and/or client-side services would be communicatively coupled (e.g., by a network) and would establish between them (or through one or more other layers and/or or other services) connections for submitting requests to the web application firewall services and/or client-side services. Other configurations of electronic devices may be used in other implementations.

During operation, an instance of the software 528 (illustrated as instance 506 and referred to as a software instance; and in the more specific case of an application, as an application instance) is executed. In electronic devices that use compute virtualization, the set of one or more processor(s) 522 typically execute software to instantiate a virtualization layer 508 and one or more software container(s) 504A-504R (e.g., with operating system-level virtualization, the virtualization layer 508 may represent a container engine (such as Docker Engine by Docker, Inc. or rot in Container Linux by Red Hat, Inc.) running on top of (or integrated into) an operating system, and it allows for the creation of multiple software containers 504A-504R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-504R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 528 is executed within the software container 504A on the virtualization layer 508. In electronic devices where compute virtualization is not used, the instance 506 on top of a host operating system is executed on the “bare metal” electronic device 500. The instantiation of the instance 506, as well as the virtualization layer 508 and software containers 504A-504R if implemented, are collectively referred to as software instance(s) 502.

Alternative implementations of an electronic device may have numerous variations from that described above. For example, customized hardware and/or accelerators might also be used in an electronic device.

FIG. 5B is a block diagram of a deployment environment according to some example implementations. A system 540 includes hardware (e.g., a set of one or more server devices) and software to provide service(s) 542, including web application firewall services and/or client-side services. In some implementations the system 540 is in one or more datacenter(s). These datacenter(s) may be: 1) first party datacenter(s), which are datacenter(s) owned and/or operated by the same entity that provides and/or operates some or all of the software that provides the service(s) 542; and/or 2) third-party datacenter(s), which are datacenter(s) owned and/or operated by one or more different entities than the entity that provides the service(s) 542 (e.g., the different entities may host some or all of the software provided and/or operated by the entity that provides the service(s) 542). For example, third-party datacenters may be owned and/or operated by entities providing public cloud services (e.g., Amazon. com, Inc. (Amazon Web Services), Google LLC (Google Cloud Platform), Microsoft Corporation (Azure)).

The system 540 is coupled to user devices 580A-580S over a network 582. The service(s) 542 may be on-demand services that are made available to one or more of the users 584A-584S working for one or more entities other than the entity which owns and/or operates the on-demand services (those users sometimes referred to as outside users) so that those entities need not be concerned with building and/or maintaining a system, but instead may make use of the service(s) 542 when needed (e.g., when needed by the users 584A-584S). The service(s) 542 may communicate with each other and/or with one or more of the user devices 580A-580S via one or more APIs (e.g., a REST API). In some implementations, the user devices 580A-580S are operated by users 584A-584S, and each may be operated as a client device and/or a server device. In some implementations, one or more of the user devices 580A-580S are separate ones of the electronic device 500 or include one or more features of the electronic device 500.

In some implementations, the system 540 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors'data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 540 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 540 may include an application platform 544 that enables PAAS for creating, managing, and executing one or more applications developed by the provider of the application platform 544, users accessing the system 540 via one or more of user devices 580A-580S, or third-party application developers accessing the system 540 via one or more of user devices 580A-580S.

In some implementations, one or more of the service(s) 542 may use one or more multi-tenant databases 546, as well as system data storage 550 for system data 552 accessible to system 540. In certain implementations, the system 540 includes a set of one or more servers that are running on server electronic devices and that are configured to handle requests for any authorized user associated with any tenant (there is no server affinity for a user and/or tenant to a specific server). The user devices 580A-580S communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the multi-tenant database(s) 546 and/or system data storage 550.

In some implementations, the service(s) 542 are implemented using virtual applications dynamically created at run time responsive to queries from the user devices 580A-580S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including the web application firewall services and/or client-side services, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 540 and the user devices 580A-580S.

Each user device 580A-580S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 540. For example, the user interface device can be used to access data and applications hosted by system 540, and to perform searches on stored data, and otherwise allow one or more of users 584A-584S to interact with various GUI pages that may be presented to the one or more of users 584A-584S. User devices 580A-580S might communicate with system 540 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 580A-580S might include an HTTP client, commonly referred to as a “browser,” for sending and receiving HTTP messages to and from server(s) of system 540, thus allowing users 584A-584S of the user devices 580A-580S to access, process and view information, pages and applications available to it from system 540 over network 582.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

What is claimed is:

1. A method of dynamically adapting content for a web page associated with an instance of a web application generated by an application platform of a database system, the method comprising:
receiving a web page request from a user;
identifying a plurality of components to be included on the web page responsive to the web page request based on an initial assessment of the user's preferences;
transmitting the web page comprising the plurality of components to the user;
inserting a plug-in mechanism in response to the web page to incorporate a plurality of selectable graphical user interface (GUI) elements associated with respective components of the plurality of components of the web page, wherein a respective selectable GUI is configurable to modify content of the respective component on the web page; and
in response to user selection of respective elements of the plurality of selectable GUI elements:
dynamically determining an updated assessment of the user's preferences based at least in part on the user selection and the initial assessment of the user's preferences; and
iteratively updating the respective components of the plurality of components of the web page associated with the respective elements of the plurality of selectable GUI elements.

2. The method of claim 1, further comprising:
rearranging multiple portions of the GUI elements on the web page based on an approval provided by the user selection.

3. The method of claim 1, further comprising:
detecting user interaction patterns based on the user selection to refine the content in real time; and
adjusting a complexity level and detail level of at least one of the GUI elements based on the user selection.

4. The method of claim 1, further comprising:
providing the GUI elements on a multimodal interface to allow the user selection through text commands, voice inputs, and gesture-based controls.

5. The method of claim 1, further comprising:
providing decentralized processing across multiple computing nodes to enable the content within the GUI elements to be refined through a distributed artificial intelligence (AI) architecture within the database system.

6. The method of claim 1, wherein refinement of the content through the user selection provides a modification of images, videos, or interactive components on the web page.

7. The method of claim 1, further comprising:
determining whether additional information on the user is required after performing the initial assessment of the user's preferences.

8. At least one non-transitory machine-readable storage medium that provides instructions that, when executed by at least one processor, are configurable to cause the at least one processor to perform operations comprising:
receiving a web page request from a user;
identifying a plurality of components to be included on the web page responsive to the web page request based on an initial assessment of the user's preferences;
transmitting the web page comprising the plurality of components to the user;
inserting a plug-in mechanism in response to the web page to incorporate a plurality of selectable graphical user interface (GUI) elements associated with respective components of the plurality of components of the web page, wherein a respective selectable GUI is configurable to modify content of the respective component on the web page; and
in response to user selection of respective elements of the plurality of selectable GUI elements:
dynamically determining an updated assessment of the user's preferences based at least in part on the user selection and the initial assessment of the user's preferences; and
iteratively updating the respective components of the plurality of components of the web page associated with the respective elements of the plurality of selectable GUI elements.

9. The at least one non-transitory machine-readable storage medium of claim 8, wherein the plug-in mechanism is used to remove portions of the content based on the user selection.

10. The at least one non-transitory machine-readable storage medium of claim 8, wherein the plug-in mechanism provides an interactive forum for the user to alert a system of specific details on the user's preferences based on the user selection.

11. The at least one non-transitory machine-readable storage medium of claim 8, wherein refinement of the content within the GUI elements is based on industry specific requirements.

12. The at least one non-transitory machine-readable storage medium of claim 8, wherein the plug-in mechanism is applied to add additional content based on the user selection and updated assessment of the user's preferences.

13. The at least one non-transitory machine-readable storage medium of claim 8, wherein the plug-in mechanism is applied to provide an interactive session to provide the user selection to clarify the user's preferences.

14. The non-transitory machine-readable storage medium of claim 8, wherein the content within the GUI elements on the web page is rearranged based on the user selection.

15. A computing device comprising:
at least one non-transitory machine-readable storage medium that stores software for a dynamic localization service; and
at least one processor, coupled to the at least one non-transitory machine-readable storage medium, to execute the software that implements the dynamic localization service and that is configurable to:
receiving a web page request from a user;
identifying a plurality of components to be included on the web page responsive to the web page request based on an initial assessment of the user's preferences;
transmitting the web page comprising the plurality of components to the user;
inserting a plug-in mechanism in response to the web page to incorporate a plurality of selectable graphical user interface (GUI) elements associated with respective components of the plurality of components of the web page, wherein a respective selectable GUI is configurable to modify content of the respective component on the web page; and
in response to user selection of respective elements of the plurality of selectable GUI elements:
dynamically determining an updated assessment of the user's preferences based at least in part on the user selection and the initial assessment of the user's preferences; and
iteratively updating the respective components of the plurality of components of the web page associated with the respective elements of the plurality of selectable GUI elements.

16. The computing device of claim 15, wherein several interactive sessions are provided in response to the plug-in mechanism to update the GUI elements based on the user selection.

17. The computing device of claim 15, wherein the plug-in mechanism is applied to indicate which content among the GUI elements that the user approves based on the user selection.

18. The computing device of claim 15, wherein the plug-in mechanism is applied to selectively cache the content aligned with the updated assessment of the user's preferences and filter the content not aligned with the updated assessment of the user's preferences.

19. The computing device of claim 15, wherein the plug-in mechanism provides for refinement of the content across multiple platforms that include web browsers, mobile applications and voice assistants.

20. The computing device of claim 15, wherein the plug-in mechanism enables the GUI element with respect to news to be adjusted according to the user selection.
